(19) United States
(12) Patent Application Publication
(10) Pub. No.: US 2011/0110459 A1
(43) Pub. Date: May 12, 2011

(54) FM OFDM over various communication media

(75) Inventor: Charles Abraham, Clarksville, MD (US)

(73) Assignee: Satius Holding, Inc.

(21) Appl. No.: 12/925,211

(22) Filed: Oct. 15, 2010

Related U.S. Application Data
(63) Continuation-in-part of application No. 10/770,342, filed on Feb. 2, 2004.

(51) Int. Cl. H04L 27/00

(52) U.S. Cl. 375/295; 375/316

(57) ABSTRACT

The present invention provides an FM Orthogonal Frequency Division Multiplexing (OFDM) modulation process that enable high-speed data communications over any transmission media and networks. The process is implemented with a modem device modulator and demodulator that provides communication with several other modem devices along any communication media that uses an FM OFDM modulation technique, a physical transmission medium such as power lines, or wireless (air), or cable, or twisted pairs communication media.

### CROSS REFERENCE TO RELATED APPLICATIONS

This application is a continuation-in-part of U.S. application Ser. No. 10/770,342, filed Feb. 2, 2004.

### BACKGROUND OF THE INVENTION

The present invention relates generally to telecommunication devices, and more particularly to a modulation technique used for enabling and transmitting various media types and digital data at very high speeds over any communication media.

Typically, a telecommunication modem is composed of two components. The first component is the modulator, which typically modulates digital data and provides that modulated data to the transmitter. The second component is the demodulator that demodulates the modulated data back to digital data.

OFDM (Orthogonal Frequency Division Multiplexing) is used in the telecommunication industry. Although it can be combined with adaptive coding and modulation techniques, such as flexible selection among different codes and coding rate, 64QAM, 32QAM, 16QAM, QPSK and BPSK constellations, to approach channel capacity, certain Signal to Noise Ratio (SNR) is required for each coding and modulation combination to achieve a desired Bit Error Rate (BER) performance. Even higher SNRs are needed if the system adopts larger alphabet size for higher data rate. Also, adaptive coding can be used with OFDM based on SNR variations. For example, when the signal is heavily attenuated through the channel, the same data can be repeated several times to boost the SNR at the receiver end for a reliable recovery. However, this would reduce the throughput of the communication system.

In order to achieve desired SNRs for reliable communication and keep the throughput high, the present invention intends to Frequency Modulate (FM) the OFDM data stream before transmission and FM demodulate the RF data stream before demodulating the OFDM data stream.

FM OFDM can gain 10-20 dB SNR that will result in significantly longer distance communication without increasing the transmit power level and significantly higher throughput to keep the high speed for the communication media. These communication media include but are not limited to AC and DC power line carrier communication, wireless communication, cable, telephone lines, twisted pairs, and coaxial cable communications. DC power line communications includes the communication over the DC wiring harness for moving vehicles like trucks, buses, SUV's and etc.

In the last several years the communication industry made new components that they started to call them “frequency modulator and frequency demodulator” incorrectly in terms of signal processing means. They are even calling these devices frequency modulation or demodulation while it has been forgotten what REAL FREQUENCY MODULATION AND DEMODULATION is. It has been over 50 years that the REAL Frequency Modulation (FM) has been discovered and used. The advantage of the FM compare to the Amplitude Modulation (AM) is that FM demodulated signals can gain significant signal to noise ratio on reception thereby the communication distance can be significantly increased. REAL FM modulation is taking the baseband signal and spreads it in frequency as a modulation factor.

### Definition of REAL Frequency Modulation (FM):

http://www.thefreedictionary.com/frequency+modulation:
a. The encoding of a carrier wave by variation of its frequency in accordance with an input signal.
b. a method of transmitting information by varying the frequency of the carrier wave in accordance with the amplitude of the input signal

### Definition of REAL Frequency Modulation (FM) by Wikipedia:

http://en.wikipedia.org/wiki/Frequency_modulation

In telecommunications and signal processing, frequency modulation (FM) conveys information over a carrier wave by varying its instantaneous frequency (contrast this with amplitude modulation, in which the amplitude of the carrier is varied while its frequency remains constant). In analog applications, the difference between the instantaneous and the base frequency of the carrier is directly proportional to the instantaneous value of the input signal amplitude. Digital data can be sent by shifting the carrier's frequency among a set of discrete values, a technique known as frequency-shift keying.

### Other Definition of REAL Frequency Modulation:

Frequency Modulation is a modulation in which the instantaneous frequency of a carrier signal departs from the center frequency of said carrier signal by a amount proportional to the instantaneous value of a modulating signal.

### Definition of Amplitude Modulation (AM)—

http://www.thefreedictionary.com/amplitude+modulation:
c. The encoding of a carrier wave by variation of its amplitude in accordance with an input signal.
d. Electronics a method of transmitting information using radio waves in which the amplitude of the carrier wave is varied in accordance with the amplitude of the input signal

Consequently, FM will have at least twice the frequency bandwidth than AM at the same speed and using the same baseband bandwidth signal. Increasing the FM frequency bandwidth—with increasing the FM modulation factor—will provide higher signal to noise ratio in the demodulated output. So, the difference between AM and FM is that AM modulates the Amplitude and FM modulates the frequency.

As an example we have AM and FM radio stations. The FM radio stations has longer communication distance with less power with clear voice recognition than AM radio station and FM radio stations quality is lot better. The baseband bandwidth of the AM and FM radio stations are around 10 Khz. The RF (radio frequency) frequency bandwidth of the FM radio stations are around 100 Khz (after FM modulation) while the AM radio stations RF frequency bandwidth is still 10 Khz.

Consequently an AM radio station baseband signal are mixed (Amplitude Modulated) with a RF carrier frequency signal while that RF frequency bandwidth remains the same as the baseband bandwidth. These called frequency up and down conversion method and has nothing to do with Frequency Modulation. FM radio stations baseband signal are Frequency Modulated to a higher RF carrier frequency band signal while the RF frequency bandwidth becomes multiple times bigger than the baseband bandwidth.

So the important issues are that AM is using a MIXER for up or down frequency conversions and the bandwidth of AM do not change. FM has a higher RF bandwidth to increase the signal to noise ratio at the receiver/demodulator. Analog FM modulator is using an Inductor and tuning diode that acts like a capacitor which will resonate at a carrier frequency. When we apply the baseband signal to this circuit than a REAL Frequency Modulation will occur. The modulation factor can be changed by applying different type of DC voltages to the tuning capacitor. Today, we can use Digital Direct Sequence (DDS) chips to create FM modulation or any digitally signal processed chips can be coded to make Frequency Modulation.

The NOT REAL Frequency Modulators and Demodulators should rather be called MIXERS or AM Modulators and Demodulators or frequency up or down converters. What they do is to add up the I and Q baseband signals and MIX them to a higher carrier frequency. The baseband bandwidth will be the same as the RF frequency bandwidth. Mostly OFDM modulation technology is using these so called Frequency Modulators and Demodulators. Similarly these so called

Frequency Demodulators is a MIXER to covert the RF frequency to baseband I and Q signals. THEREFORE these so called Frequency Modulators and Demodulators in the following patents:
d. US patent Application Publication No: 2004/0042387
e. U.S. Pat. No. 5,559,377
f. U.S. Pat. No. 5,521,943
g. U.S. Pat. No. 5,845,885
h. US patent Application Publication No: 2004/0223553
i. U.S. Pat. No. 4,968,970
j. U.S. Pat. No. 6,256,290
are all using AM modulation with a MIXER. None of them describes the REAL FM modulator and demodulator.

### SUMMARY OF THE INVENTION

Briefly stated, in a first embodiment, the present invention defines a new modulation technique that enable high-speed data communications over any transmission media and networks. The FM OFDM modulation technique for communication comprises:

a modem device that provides communication with several other modem devices along any communication media that uses FM OFDM modulation technique,
a physical transmission medium, including but not limited to various power lines, or wireless (air), or cable, or twisted pairs communication media.
a modem device modulator that receives bit streams from video, voice, internet or other digital data sources, and which consists of a FM OFDM modulator that comprises:
1. receiver feedback information retrieval
2. coding scheme selection
3. coding and interleaving
4. constellation selection among BPSK, QPSK, 16 QAM, etc.
5. digital modulation
6. pilot symbol insertion
7. carrier mapping

### 8. IFFT (Inverse Fast Fourier Transfer)

9. adding cyclic prefix
10. peak limiting
11. low pass filtering
12. ADC (analog to digital converter)

### 13. FM (Frequency Modulator) for I and Q

and a modem device demodulator that sends bit streams to video, voice, internet or other data sources, and which consists of a FM OFDM demodulator that comprises:
1. decoding and de-interleaving
2. demodulation (BPSK, QPSK, 16 QAM, etc.)
3. channel estimation
4. carrier demapping

### 5. FFT (Fast Fourier Transfer)

6. cyclic prefix removal
7. frequency offset estimation and compensation
8. synchronization and timing offset estimation
9. DAC (digital to analog converter)

### 10. FM (Frequency Demodulator)

The present invention can also be used as coded and/or adaptive and/or orthogonal Frequency Modulated (FM) Orthogonal Frequency Division Multiplexing (OFDM) as well as coded and/or adaptive and/or orthogonal Frequency Modulated (FM) Frequency Division Multiplexing (FDM).

For the purpose of this specification, the term digital signal processor (DSP) refers to any device, programmable or hardwired, that performs mathematical and logical calculations on digitized signals for the purpose of transforming said signals from one format or domain to another (such as sampled time domain signals to frequency domain signals), or modifies or conditions said signals (such as by filtering, frequency conversion, etc) in a manner equivalent to the way analog signals are processed by analog components.

In this specification, the digital signal processing elements are programmed as logic elements embedded in a programmable hardware chip, such as a Field Programmable Gate Array (FPGA). However, these elements could also be embedded in an Application Specific Integrated Circuit (ASIC), or the digital signal processing operations could be performed in software via a dedicated general purpose Digital Signal Processing integrated circuit, or by other means.

Orthogonal Frequency Division Multiplexing (OFDM) refers to a modulation technique in which multiple carriers, orthogonal to each other in frequency space, carry multiple data units of information simultaneously and independently of each other. The independence comes from the orthogonality of the frequency carriers.

In the present design, the OFDM signal is processed predominantly in the digital domain, using digital signal processing techniques. The analog equivalent signals are converted to and from the digital domain by means of conventional Analog to Digital Converters (ADC) and Digital to Analog Converters (DAC).

### BRIEF DESCRIPTION OF THE DRAWINGS

The foregoing summary, as well as the following detailed description of the preferred embodiments of the invention, will be better understood when read in conjunctions with the appended drawings. For the purpose of illustrating the invention, there are shown in the drawings embodiments that are presently preferred. It should be understood, however, that the invention is not limited to the precise arrangement and instrumentalities shown. In the drawings, like numerals are used to indicate like elements throughout. In the drawings:

FIG. 1 is a graphical illustration of the OFDM (Orthogonal Frequency Division Multiplexing) transmitter (modulator) for power line carrier (PLC) communication that includes a power line coupler, RF and analog circuitry, in accordance with one preferred embodiment of the present invention.

FIG. 2 is a graphical illustration of the OFDM (Orthogonal Frequency Division Multiplexing) receiver (demodulator) for power line carrier communication that includes a power line coupler, RF and analog circuitry, in accordance with one preferred embodiment of the present invention.

FIG. 3 is one of the graphical illustrations of the FM (Frequency Modulated) OFDM (Orthogonal Frequency Division Multiplexing) transmitter (modulator) for power line communication that includes a power line coupler, RF and analog circuitry, in accordance with one preferred embodiment of the present invention.

FIG. 3A is another graphical illustration of the FM (Frequency Modulated) OFDM (Orthogonal Frequency Division Multiplexing) transmitter (modulator) for power line communication that includes a power line coupler, RF and analog circuitry, in accordance with one preferred embodiment of the present invention.

FIG. 4 is one of the graphical illustrations of the FM (Frequency Demodulated) OFDM (Orthogonal Frequency Division Multiplexing) receiver (demodulator) for power line communication that includes a power line coupler, RF and analog circuitry, in accordance with one preferred embodiment of the present invention.

FIG. 4A is another graphical illustration of the FM (Frequency Demodulated) OFDM (Orthogonal Frequency Division Multiplexing) receiver (demodulator) for power line communication that includes a power line coupler, RF and analog circuitry, in accordance with one preferred embodiment of the present invention.

FIG. 5 is one of the graphical illustrations of the FM modulator using Direct Digital Synthesizer (DDS), in accordance with one preferred embodiment of the present invention.

FIG. 6 is another graphical illustration of the FM modulator, in accordance with one preferred embodiment of the present invention.

FIG. 7 is a graphical illustration of a typical FM demodulator, in accordance with one preferred embodiment of the present invention.

### DETAILED DESCRIPTION OF THE INVENTION

The present invention presents improvements to an OFDM based communication application by FM modulating the OFDM signals before transmission and FM demodulating the carrier frequencies before OFDM demodulation.

FM modulation is well known to be used for a number of applications where long distance communications are important. Typically, FM modulation can gain 10-40 dB SNR (signal to noise ratio) depending on the modulation factor that is being used. Bandwidth determines the SNR. Larger bandwidth communication devices have smaller SNR than smaller bandwidth devices. To reach high speed communication, the requirements will be higher bandwidth. If single or a couple of carrier frequencies are being used for communication, then the bandwidth will need to be larger and therefore the SNR will be lower. Even if FM modulation is used for high speed data communication, the SNR will be lower than an OFDM system.

For example, if one needs to reach 10 Mbps speed over a communication media by using a 250 Mhz FM modulated carrier frequency over a 60 Mhz bandwidth, then the level of noise will be about −67 dBm. Even recovering about 15-20 dB SNR by using FM still will not provide reliable long distance communications because the noise level is too high. By using 1024 carriers for OFDM with 30 Mhz bandwidth at a center frequency of 250 Mhz, one can reach up to 150 Mbps speed with a noise level of −86 dBm at every 30 Khz carrier frequency. Consequently OFDM could reach longer distance and higher speed communication than FM although it will depend on the transmitted power too. OFDM will be a better choice for FCC emission consideration.

Block-Wise Description of the OFDM or FDM System from Modulator's Viewpoint
1. feedback from the receiver is retrieved to make a judgment on the forward direction channel quality;
2. the code selection unit picks up a coding scheme based on the previously made channel quality judgment, different codes can be used for higher data rate at the target performance requirement, for example a rate ½ code can be used to replace a rate ⅓ code when the SNR is high;
3. in the coding and interleaving unit, digital streams are encoded with the selected code, either a convolutional or a block code, the output of the encoder is interleaved so that errors due to channel distortion scatter across the stream independently;
4. the constellation selection unit picks up a signal constellation, or alphabet, among BPSK, QPSK, QAM etc. based on the previously made channel quality judgment, different alphabets can be used for higher data rate at the target performance requirement, for example 6 4-QAM or 16-QAM can be used to replace QPSK or BPSK when the SNR is high;
5. the modulator maps binary output from the coding and interleaving unit to real or complex numbers in the chosen alphabet by the constellation selection unit;
6. pilot symbols are inserted into the symbol stream from the modulator based on a channel estimation algorithm of different kinds;
7. output of the previous unit is then mapped onto specific bins of an Inverse Fast Fourier Transform (IFFT) unit;
8. IFFT unite conducts discrete Fourier transform on the input data;
9. the tailing part of an IFFT output block is prepended to the block in this unit to combat the distortion due to multipath propagation, the prepended part is called Cyclic Prefix (CP);
10. a limitor is used to make sure the signal is within the amplifier's dynamic range;
11. an optional digital low pass filter is used to confine the signal within the desired band, this functionality can also be achieved with an analog low pass filter.
12. the in-phase (I) and quadrature (Q) signal components are then fed to two separate Digital to Analog Converters (DACs). The analog outputs of the DACs are amplified, filtered and mixed with the local oscillator (LO) signal.
13. the mixer output is then sequentially filtered, amplified and fed to a coupler or antenna.
14. the coupler or antenna injects carrier frequency signals into physical media.
   Block-Wise Description of the OFDM or FDM System from Demodulator's Viewpoint

In the analog part, the carrier frequency signals retrieved from physical transmission media by means of a coupler is amplified, filtered and mixed to generate the intermediate frequency (IF) signal, the IF signal is further amplified, filtered and mixed to generate the baseband signal. This baseband signal is again amplified and filtered. The I and Q components of the filter output are fed into two separate Analog to Digital Converters (ADCs). The digitized I/Q components then propagate through the following blocks:
1. The digital I/Q signals first go through a unit that finds the start and end of a data frame;
2. The second unit estimates and compensates for frequency offset, i.e., the difference between transmit LO frequency and receive LO frequency embedded in the I/Q samples;
3. The third unit removes the cyclic prefix of each IFFT block;
4. The fourth unit conducts Fast Fourier Transform (FFT) on each IFFT block after CP is removed;
5. Carrier demapper separates the pilot and information bearing bins in the output of FFT unit;
6. The channel estimation unit generates estimates of noise power and channel gain at each FFT bin;
7. With the help of channel gain and noise power estimates, the demodulator generates hard or soft decisions on the modulating bits;
8. The de-interleaver permutes the hard or soft decisions and then feeds its output to a decoder which generates bit streams to be delivered to the upper layer applications such as interne, video/audio/telephone/data.

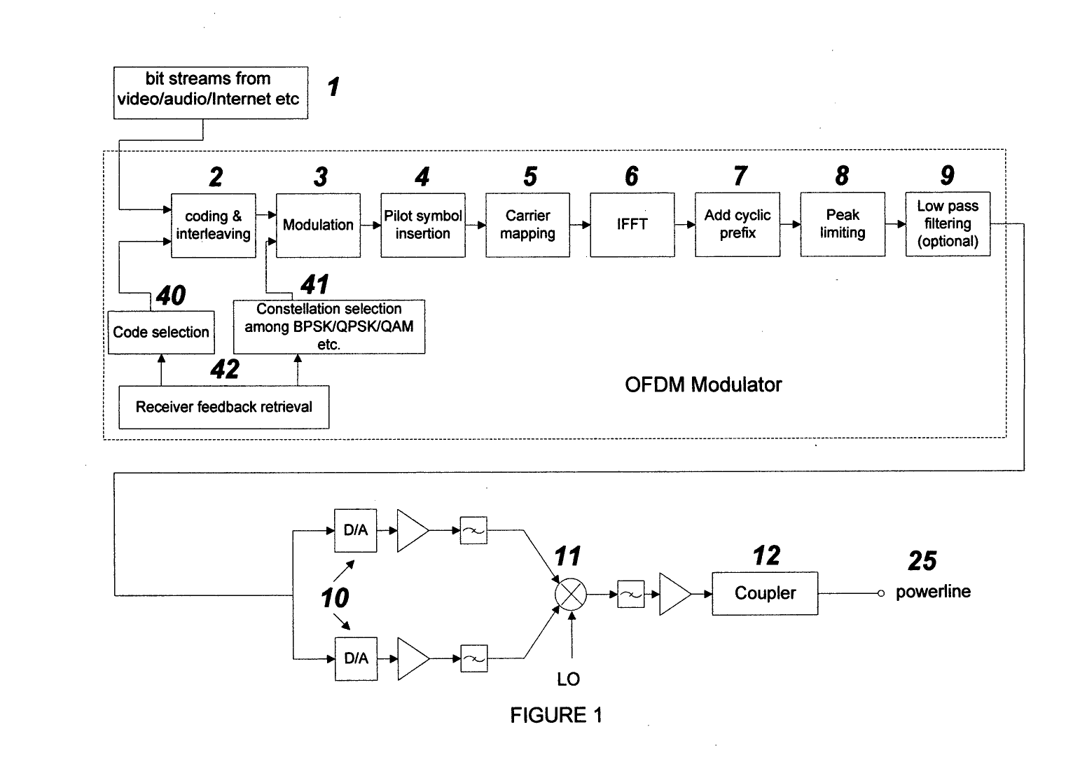

FIG. 1 shows the transmitter, coupler and Orthogonal Frequency Division Multiplexing (OFDM) Modulator, which is a multi-carrier modulation scheme by means of Fast Fourier Transform (FFT). This modulation scheme takes as input bit streams 1 from any application, such as voice/video/audio/internet. It retrieves forward channel quality feedback from the receiver 42 and selects a good code 40, such as a block code or a convolutional code, to encode the bit streams accordingly, then interleaves 2 the encoded bits to break error bursts at the receiver end into scattered individual errors across the whole transmission. The Receiver feedback retrieval 42, the Code Selection 40, the Constellation selection 41, coding & interleaving 2, and modulation 3 accomplishes the adaptive coding and adaptive modulation for the OFDM system. The OFDM system further converts interleaved bits into real or complex symbols in an alphabet 3 which is selected 41 based on channel condition feedback. Different alphabets can be used for a higher data rate at the target performance requirement, for example 64-QAM or 16-QAM can be used to replace QPSK or BPSK when the channel signal to noise ratio is high. After pilot symbols 4 are inserted, the composite symbol stream modulates specific carriers 5 via Inverse Fast Fourier Transform (IFFT) 6. A tailing part is copied to the beginning of the IFFT results to make the Cyclic Prefix (CP) 7. A limitor 8 is used to make sure the digital signal is within the amplifier's dynamic range. An optional digital low pass filter 9 can also be used to confine the signal within the desired band. This functionality may alternatively be achieved with an analog low pass filter. The in-phase (I) and quadrature (Q) components of the digital signal are now fed to two separate Digital to Analog Converters (DACs) 10. The analog outputs of the DACs are amplified, filtered and mixed 11 with the local oscillator (LO) signal. The mixer output is sequentially filtered, amplified and sent to a coupler or antenna 12, which will transmit the DSP carrier frequency signals to the communication media 25 like power line, air, coax cable, or twisted pair cable.

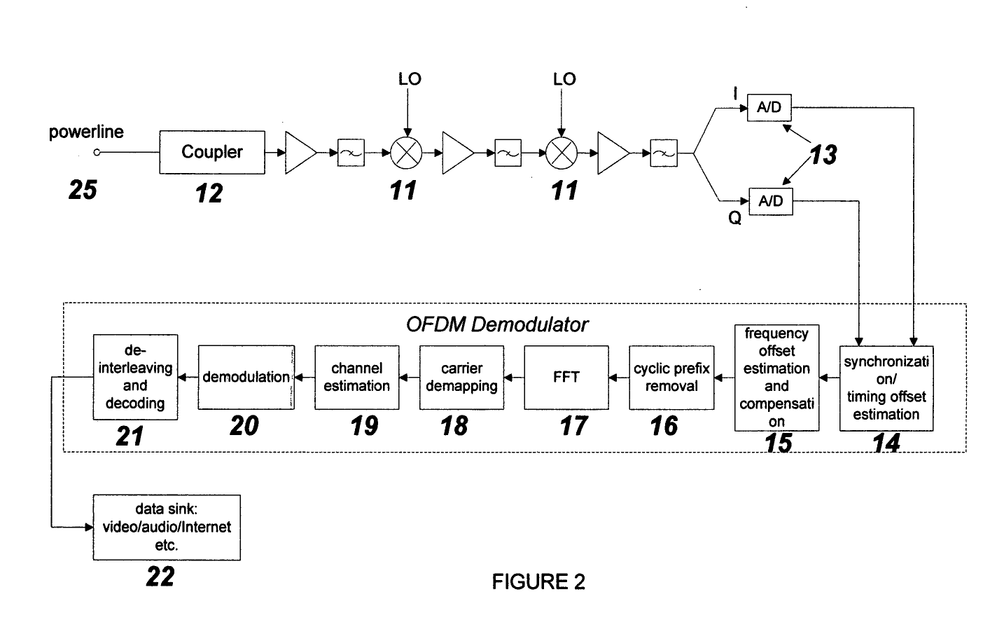

FIG. 2 shows the receiver, coupler and Orthogonal Frequency Division Multiplexing (OFDM) Demodulator. In the analog part, the carrier frequency signal retrieved from physical transmission media 25 by means of a coupler or antenna 12 is amplified, filtered and mixed 11 to generate the intermediate frequency (IF) signal, and the IF signal is again amplified, filtered and mixed 11 to generate the base band signal. This base band signal is further amplified and filtered. The I and Q components of the filter output are sent to two separate Analog to Digital Converters (ADCs) 13. From the digitized I/Q components, the frame header is located by means of synchronization algorithms 14. Frequency offset 15 or the difference between transmit LO and receive LO is estimated and compensated. Based on the knowledge of the frame header, the cyclic prefix 16 of each transmitted IFFT block is removed and Fast Fourier Transform (FFT) 17 is conducted. From obtained results on pilot-bearing carriers 18, channel estimation algorithm 19 delivers noise power and channel gain estimates which facilitates the generation of hard or soft decisions on the encoded bits 20. The hard or soft decisions are finally de-interleaved and fed to the decoder 21 that gives bit streams 22 transmitted for upper layer applications such as internet, video/audio/data.

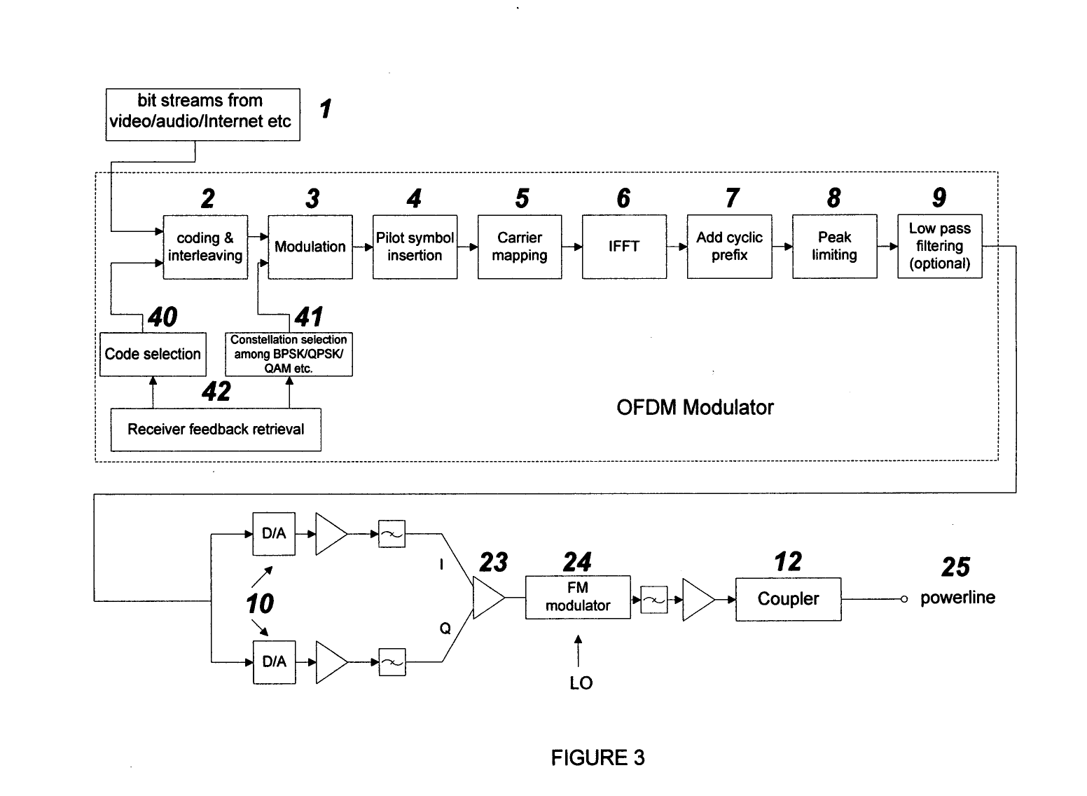

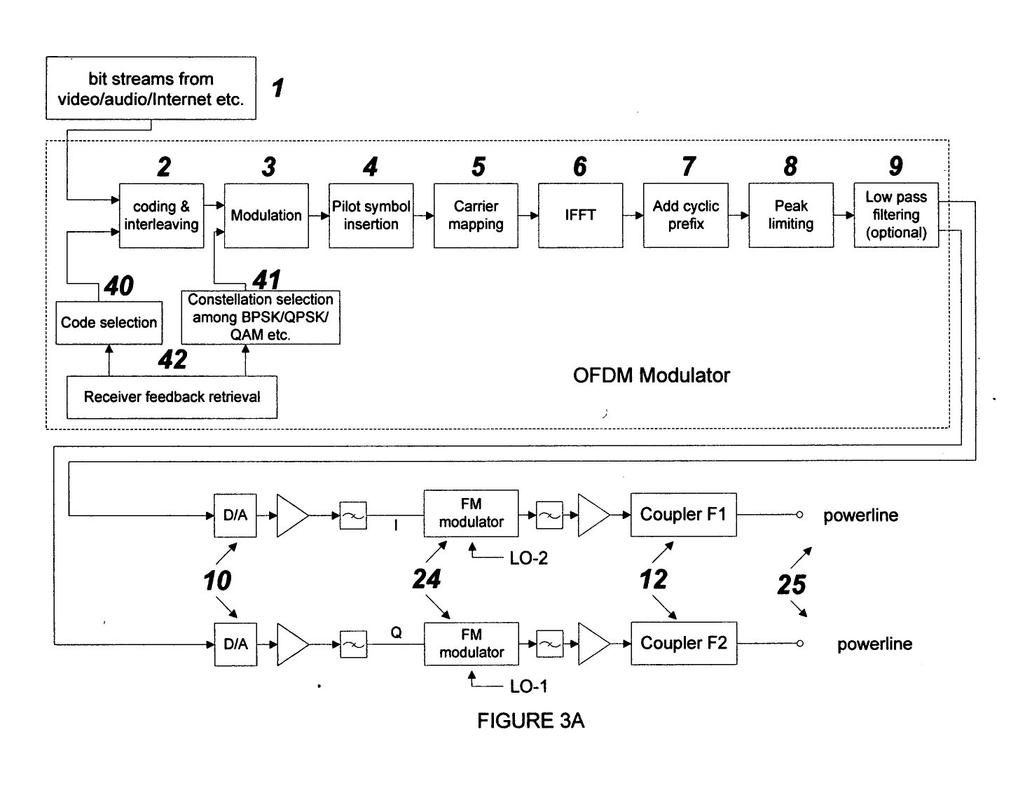

FIG. 3 shows the Frequency Modulated (FM) Orthogonal Frequency Division Multiplexing (OFDM) Modulator which is a multi-carrier modulation scheme by means of Fast Fourier Transform (FFT). This modulation scheme takes as input bit streams 1 from any application, such as voice/video/audio/internet. It retrieves forward channel quality feedback from the receiver 42 and selects a good code 40, such as a block code or a convolutional code, to encode the bit streams accordingly, then interleaves 2 the encoded bits to break error bursts at the receiver end into scattered individual errors across the whole transmission. The Receiver feedback retrieval 42, the Code Selection 40, the Constellation selection 41, coding & interleaving 2, and modulation 3 accomplishes the adaptive coding and adaptive modulation for the OFDM system. The OFDM system further converts interleaved bits into real or complex symbols in an alphabet 3 which is selected 41 based on channel condition feedback. Different alphabets can be used for a higher data rate at the target performance requirement, for example 64-QAM or 16-QAM can be used to replace QPSK or BPSK when the channel signal to noise ratio is high. After pilot symbols 4 are inserted, the composite symbol stream modulates specific carriers 5 via Inverse Fast Fourier Transform (IFFT) 6. A tailing part is copied to the beginning of the IFFT results to make the Cyclic Prefix (CP) 7. A limitor 8 is used to make sure the digital signal is within the amplifier's dynamic range. An optional digital low pass filter 9 can also be used to confine the signal within the desired band. This functionality may alternatively be achieved with an analog low pass filter. The in-phase (I) and quadrature (Q) components of the digital signal are now fed to two separate Digital to Analog Converters (DACs) 10. The analog outputs of the DACs are amplified, filtered, I and Q is converted together 23 and FM Modulated 24 with the local oscillator (LO) signal. The FM Modulator 24 output is sequentially filtered, amplified and sent to a coupler or antenna 12, which will transmit the DSP carrier frequency signals to the communication media 25 like power line, air, coax cable, or twisted pair cable.

FIG. 3A shows another embodiment of the Frequency Modulated (FM) Orthogonal Frequency Division Multiplexing (OFDM) Modulator, when I and Q base band converter 23 is not developed yet, which is a multi-carrier modulation scheme by means of Fast Fourier Transform (FFT). This modulation scheme takes as input bit streams 1 from any application, such as voice/video/audio/internet. It retrieves forward channel quality feedback from the receiver 42 and selects a good code 40, such as a block code or a convolutional code, to encode the bit streams accordingly, then interleaves 2 the encoded bits to break error bursts at the receiver end into scattered individual errors across the whole transmission. The Receiver feedback retrieval 42, the Code Selection 40, the Constellation selection 41, coding & interleaving 2, and modulation 3 accomplishes the adaptive coding and adaptive modulation for the OFDM system. The OFDM system further converts interleaved bits into real or complex symbols in an alphabet 3 which is selected 41 based on channel condition feedback. Different alphabets can be used for a higher data rate at the target performance requirement, for example 64-QAM or 16-QAM can be used to replace QPSK or BPSK when the channel signal to noise ratio is high. After pilot symbols 4 are inserted, the composite symbol stream modulates specific carriers 5 via Inverse Fast Fourier Transform (IFFT) 6. A tailing part is copied to the beginning of the IFFT results to make the Cyclic Prefix (CP) 7. A limitor 8 is used to make sure the digital signal is within the amplifier's dynamic range. An optional digital low pass filter 9 can also be used to confine the signal within the desired band. This functionality may alternatively be achieved with an analog low pass filter. The in-phase (I) and quadrature (Q) components of the digital signal are now fed to two separate Digital to Analog Converters (DACs) 10. The analog outputs of the DACs are amplified, filtered, and I and Q is separately FM Modulated 24 with two different local oscillator (LO) signals. The two FM Modulators 24 output will create 2 separate frequency bands F1 and F2 (for I and Q) for communication which is sequentially filtered, amplified and sent to a coupler F1 and coupler F2 or antenna F1 and antenna F2 12, which will transmit the DSP carrier frequency signals to the communication media 25 like power line, air, coax cable, or twisted pair cable.

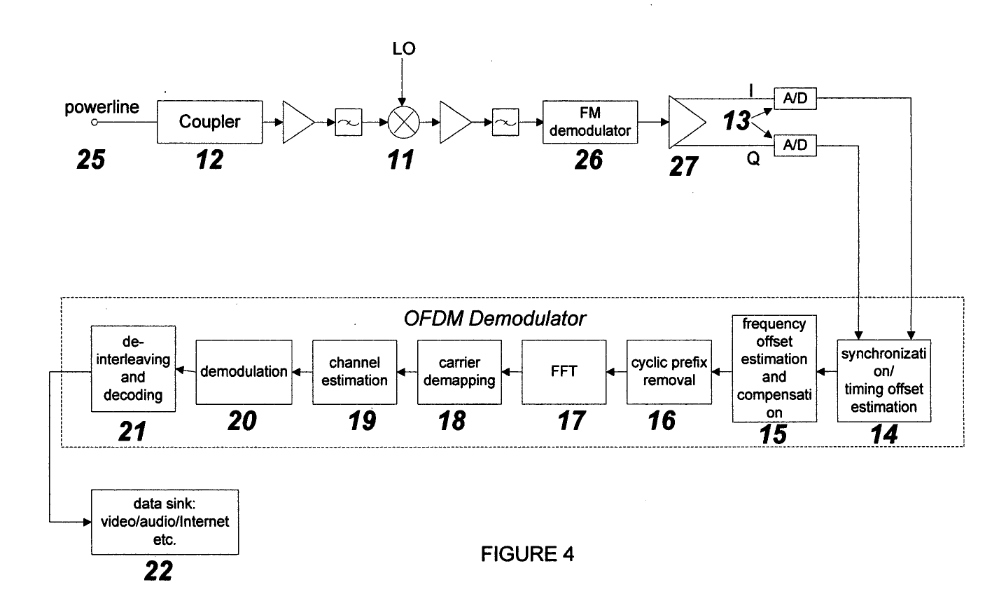

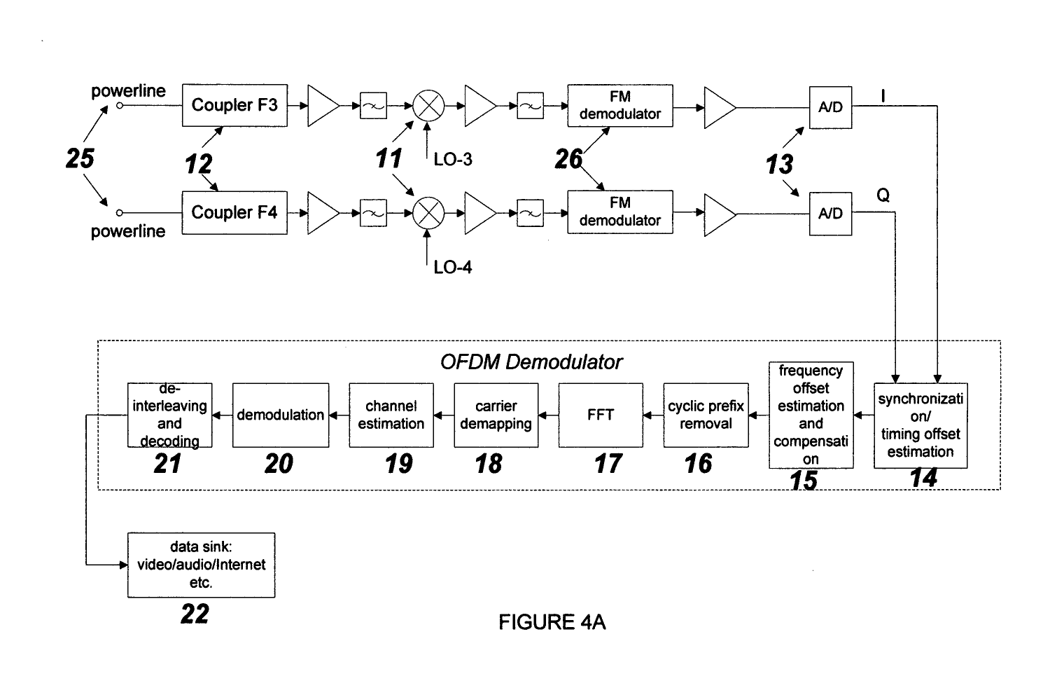

FIG. 4 shows the receiver, coupler, FM demodulator and Orthogonal Frequency Division Multiplexing (OFDM) Demodulator. In the analog part, the carrier frequency signal retrieved from physical transmission media 25 by means of a coupler or antenna 12 is amplified, filtered and mixed 11 to generate the intermediate frequency (IF) signal, and the IF signal is again amplified, filtered and FM Demodulated 26 to generate the base band signal. This base band signal is further converted 27 into I and Q, amplified and filtered. The I and Q components of the filter output are sent to two separate Analog to Digital Converters (ADCs) 13. From the digitized I/Q components, the frame header is located by means of synchronization algorithms 14. Frequency offset 15 or the difference between transmit LO and receive LO is estimated and compensated. Based on the knowledge of the frame header, the cyclic prefix 16 of each transmitted IFFT block is removed and Fast Fourier Transform (FFT) 17 is conducted. From obtained results on pilot-bearing carriers 18, channel estimation algorithm 19 delivers noise power and channel gain estimates which facilitates the generation of hard or soft decisions on the encoded bits 20. The hard or soft decisions are finally de-interleaved and fed to the decoder 21 that gives bit streams 22 transmitted for upper layer applications such as internet, video/audio/data.

FIG. 4A is another embodiment of the FM OFDM demodulator when the base band converted 27 into I and Q is not developed yet. In this case, I and Q is separately FM demodulated from two different frequency bands like F3 and F4 and sent to the OFDM demodulator for data recovery. In the analog part, the two carrier frequency band signal F3 and F4 is retrieved from physical transmission media 25 by means of a coupler F3 and F4 or antenna F3 and F4 12 is amplified, filtered and mixed 11 to generate the intermediate frequency (IF) signal, and the IF signal is again amplified, filtered and F3 and F4 frequency bands are separately FM Demodulated 26 to generate the base band signal. These base band I and Q signals separately are further amplified and filtered. The I and Q components of the filter output are sent to two separate Analog to Digital Converters (ADCs) 13. From the digitized I/Q components, the frame header is located by means of synchronization algorithms 14. Frequency offset 15 or the difference between transmit LO and receive LO is estimated and compensated. Based on the knowledge of the frame header, the cyclic prefix 16 of each transmitted IFFT block is removed and Fast Fourier Transform (FFT) 17 is conducted. From obtained results on pilot-bearing carriers 18, channel estimation algorithm 19 delivers noise power and channel gain estimates which facilitates the generation of hard or soft decisions on the encoded bits 20. The hard or soft decisions are finally de-interleaved and fed to the decoder 21 that gives bit streams 22 transmitted for upper layer applications such as internet, video/audio/data.

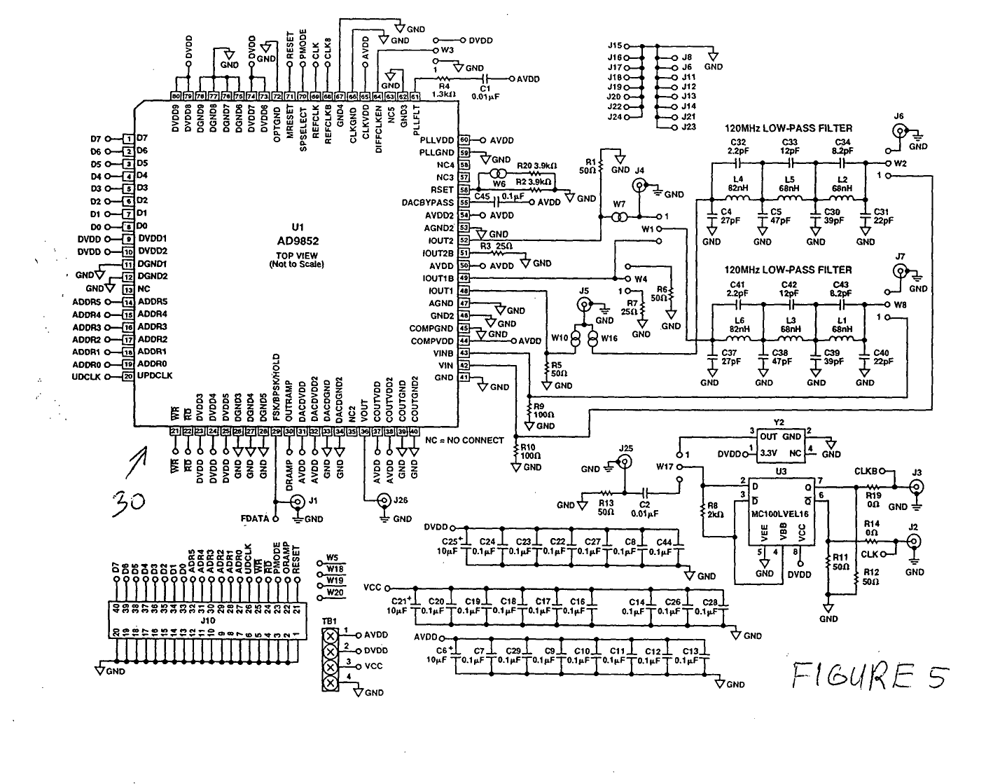

FIG. 5 shows an embodiment of an FM modulator which uses AD9852 Integrated Circuits (IC) from Analog Devices, Inc. This IC is a Direct Digital Synthesizer (DDS) 30 and includes the D/A converters 10 and the FM modulator 24.

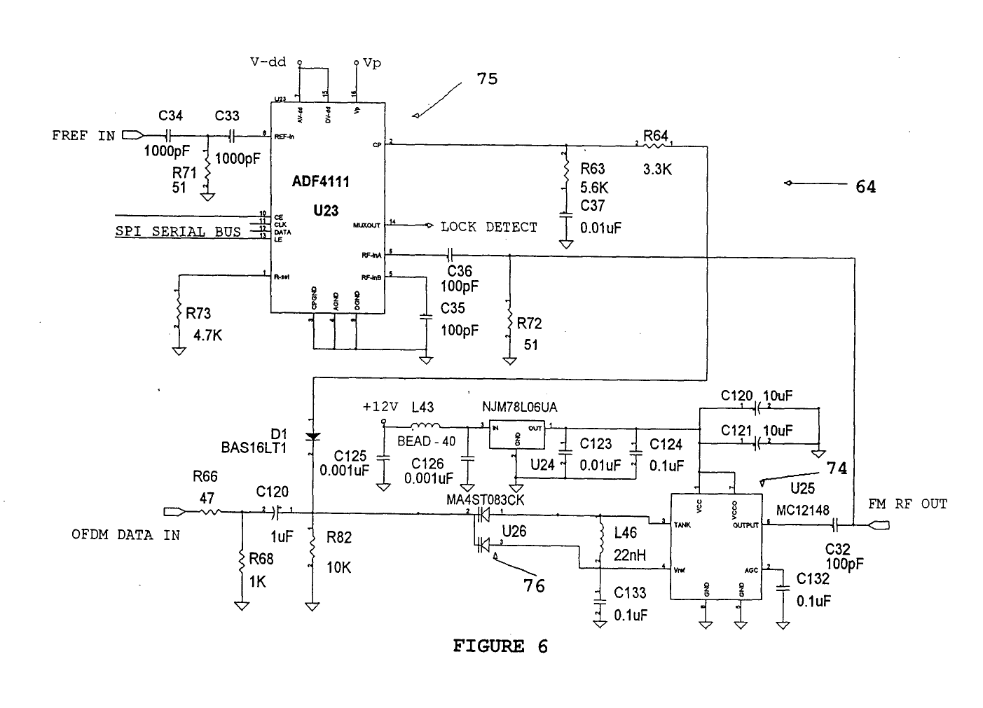

FIG. 6 shows another embodiment of an FM modulator 64 that uses a Phase Lock Loop (PLL) IC 75 such as the ADF4111 IC, a Voltage controlled oscillator (VCO) 74 such as the MC12148 IC (available from Motorola), and a varactor diode 76 such as the MA4ST083CK (available from M/A-COM, Lowell, Mass.). The varactor 76 oscillates with the L46 inductor to create the oscillation frequency and the FM modulation, while the PLL 75 controls and stabilize the carrier frequency for the VCO 74.

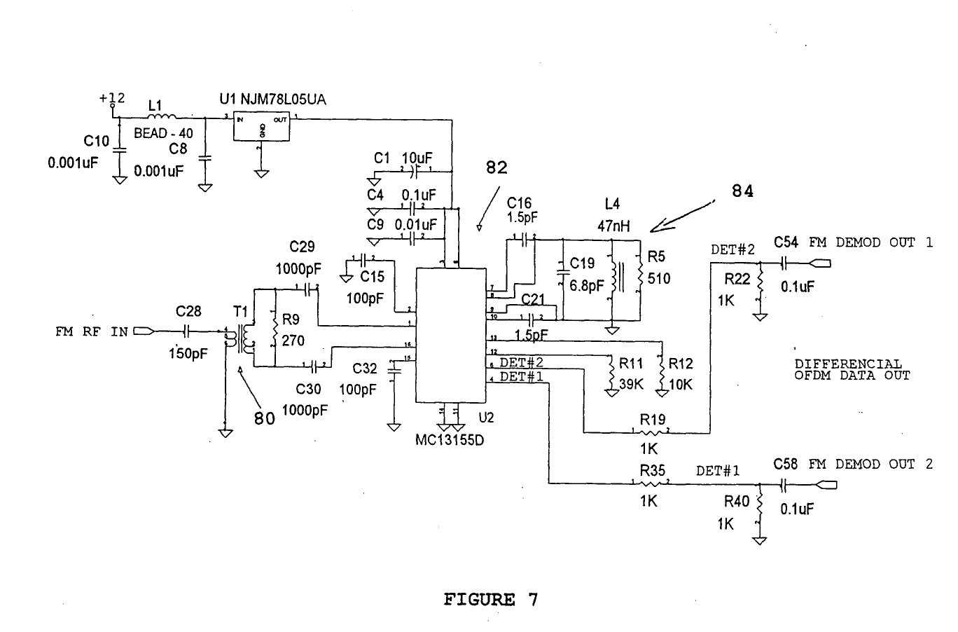

FIG. 7 shows an embodiment of the FM demodulator 26 where an MC13155D (available from Motorola) wideband FM limiter IC is used with a RLC tank circuit 84 that determines the carrier frequency and its necessary bandwidth for detection.

Another example of an FM demodulation scheme is to use a PLL with VCO and charge pump.

The challenge to do FM OFDM is that OFDM carrier frequencies do not come out as a flat frequency response from the D/A converters. The magnitude variations between each carrier frequency can usually reach 12 dB. Thus, the OFDM processing needs to include more processing power and higher sampling rates in order to get the OFDM carrier frequencies smaller magnitude variations.

Furthermore, this FM OFDM modulation can also be used as coded and/or adaptive and/or orthogonal FM OFDM modulation and demodulation system too. The FM modulation signal can be further coded to be used as either FSK or a type of multiple level FSK modulation after OFDM has been modulated. For example, The OFDM modulated carrier frequencies can be modulated again to gain extra speed by modulating that by multi-level FM modulation where the FM bands would be in different frequency bands at one time while each bad would be identified to be a coded digital symbols. If 4 level of FM modulation is used then there will be 4 different frequency bands, each coded to as F1 band to be “00”, F2 band to be “01”, F3 bands to be “10” and F4 bands to be “11”. This way the actual speed of the FM OFDM system would be increase by a factor of 4, while it would use about 4 times more bandwidth. This coded sequence and/or this multi level of FM modulation of course be decrease or increase as it desired which will decrease or increase the final communication speed and can also be made adaptive modulation as well. The advantage of this FM OFDM or coded FM OFDM communication modulation is that the communication distance can be increased while keeping very high speed data over the communication media.

Any type of antenna can be used with this FM OFDM modulation for wireless application including the chip antenna.

For power line communication, any type of coupler can be used. The present invention prefers to use a capacitive coupler or resin/dielectric-filled coupler for overhead or for underground power lines. A coupler is a transformer. Thus, a transformer can be a capacitive transformer to become a capacitive coupler. A resin-filled coupler means that a transformer is filled in resin. A dielectric-filled coupler means that a transformer is filled with a dielectric material. A capacitive transformer can also be filled with resin or other dielectric material. The transformer primary impedance is the same order of magnitude as that of overhead or underground power lines or larger. A capacitive coupler with a data port may be used here to couple a modem to the line. The line, may be terminated with a resistance approximately equal to the characteristic impedance of the power transmission cable. Modem means herein is the modulator and demodulator. The secondary side of a capacitive coupler that connects to the transmitter and/or receiver is wound about equal number of turns as the primary side of the coupler that is connected through a capacitor to the power line. The coupler has a core between the primary and secondary winding. This coupler can be used for any high voltage power line between 120V AC to 750 KV AC with the necessary safety changes. The most preferred coupler for power line communication is the matching coupler that can match the power line characteristic impedance to the coupler and the coupler can also match the characteristic impedance of the transmitter receiver at anytime and any location.

Changes can be made to the embodiments described above without departing from the broad inventive concept thereof. The present invention is thus not limited to the particular embodiments disclosed, but is intended to cover modifications within the spirit and scope of the present invention.

What is claimed is:

1. A communication apparatus for communicating electric signals through wireless, or coax cable, or twisted pair or one or more electric lines comprising:
an Orthogonal Frequency Division Multiplexing (OFDM) or FDM modulator that transmits said multi-carrier modulation scheme by means of FFT said includes adaptive modulation, said includes adaptive coding;
a FM modulator that modulates the OFDM or FDM modulated carrier frequencies;
a first coupler or antenna connected between the electrical line or air and the transmitter, and communicating the modulated carrier frequency signals to the electric line or air; and
a transmitter operatively connected to the modulator and the output side to the coupler or antenna and said transmitter transmitting the modulated carrier frequency signals;
and wherein frequency modulation includes a modulation in which a method of transmitting information by varying the frequency of the carrier wave in accordance with the amplitude of the input signal.

2. The communication apparatus of claim 1 wherein the coupler is a transformer.

3. The communication apparatus of claim 1 wherein the coupler is a capacitive transformer.

4. The communication apparatus of claim 1 wherein the coupler is a resin filled transformer.

5. The communication apparatus of claim 1 wherein the coupler is a dielectric filled transformer.

6. The communication apparatus of claim 1 wherein the coupler is a matching coupler that can match the power line characteristic impedance to the coupler and the coupler can also match the characteristic impedance of the transmitter receiver at anytime and any location.

7. The communication apparatus of claim 1 wherein the antenna is a chip antenna.

8. The communication apparatus of claim 1 wherein a communication apparatus for communicating electric signals through one or more electric lines comprising:
an Orthogonal Frequency Division Multiplexing (OFDM) or FDM demodulator that
receives said multi-carrier modulation scheme by means of FFT said includes adaptive modulation, said includes adaptive coding;
a FM demodulator that demodulates the FM OFDM or FM FDM modulated carrier frequencies sends the OFDM or FDM modulated carrier frequencies to the OFDM or FDM demodulator;
a second coupler or antenna connected between the electrical line or air and the receiver, and communicating the modulated carrier frequency signals to the demodulator;
a receiver operatively connected to the demodulator and the input side to the coupler or antenna and said receiver receiving the modulated carrier frequency signals;
and wherein frequency modulation includes a modulation in which a method of transmitting information by varying the frequency of the carrier wave in accordance with the amplitude of the input signal.

9. A communication apparatus for communicating electric signals through one or more electric lines comprising:
an Orthogonal Frequency Division Multiplexing (OFDM) or FDM modulator that transmits said multi-carrier modulation scheme by means of FFT said includes adaptive modulation, said includes adaptive coding;
a FM modulator that modulates the OFDM or FDM modulated carrier frequencies;
a first coupler connected between the electrical line and the transmitter, and communicating the modulated carrier frequency signals to the electric line;
a transmitter operatively connected to the modulator and the output side to the coupler and said transmitter transmitting the modulated carrier frequency signals;
and wherein frequency modulation includes a modulation in which a method of transmitting information by varying the frequency of the carrier wave in accordance with the amplitude of the input signal.

10. The communication apparatus of claim 9 wherein the coupler is a transformer.

11. The communication apparatus of claim 9 wherein the coupler is a capacitive transformer.

12. The communication apparatus of claim 9 wherein the coupler is a resin filled transformer.

13. The communication apparatus of claim 9 wherein the coupler is a dielectric filled transformer.

14. The communication apparatus of claim 9 wherein the coupler is a matching coupler that can match the power line characteristic impedance to the coupler and the coupler can also match the characteristic impedance of the transmitter receiver at anytime and any location.

15. The communication apparatus of claim 9 wherein a communication apparatus for communicating electric signals through one or more electric lines comprising:
an Orthogonal Frequency Division Multiplexing (OFDM) or FDM demodulator that
receives said multi-carrier modulation scheme by means of FFT said includes adaptive modulation, said includes adaptive coding;
a FM demodulator that demodulates the FM OFDM or FM FDM modulated carrier frequencies, located between the coupler and the ADCs and sends the OFDM or FDM modulated carrier frequencies to the OFDM or FDM demodulator;
a second coupler connected between the electrical line and the receiver, and communicating the modulated carrier frequency signals to the demodulator;
a receiver operatively connected to the demodulator and the input side to the coupler and said receiver receiving the modulated carrier frequency signals.

16. A communication apparatus for communicating electric signals through one or more electric lines comprising:
an Orthogonal Frequency Division Multiplexing (OFDM) or FDM modulator that
transmits said multi-carrier modulation scheme by means of FFT said includes adaptive modulation, said includes adaptive coding;
a first coupler connected between the electrical line and the transmitter, and communicating the modulated carrier frequency signals to the electric line;
a transmitter operatively connected to the modulator and the output side to the coupler and said transmitter transmitting the modulated carrier frequency signals;
and wherein frequency modulation includes a modulation in which a method of transmitting information by varying the frequency of the carrier wave in accordance with the amplitude of the input signal.

17. An apparatus for transmitting a frequency modulated orthogonal frequency division multiplex (FM/OFDM) communication signal over a transmission medium comprising:
an assembly of digital signal processing units adapted to process an incoming baseband signal and to output an in-phase signal and a quadrature signal, the in-phase signal and the quadrature signal in combination, forming an orthogonal frequency division multiplex (OFDM) signal;
a first frequency modulation modulator adapted to receive the in-phase signal; and
a second frequency modulation modulator adapted to receive the quadrature signal,
wherein the first frequency modulation modulator and the second frequency modulation modulator are each adapted to provide an output to the transmission medium in separate frequency bands,
and wherein frequency modulation includes a modulation in which the instantaneous frequency of a carrier signal departs from the center frequency of said carrier signal by an amount proportional to the instantaneous value of a modulating signal.

18. The apparatus of claim 17, wherein the transmission medium is an electrical power line and the apparatus further includes:
a first coupler adapted to receive the output of the first frequency modulation modulator, and
a second coupler adapted to receive the output of the second frequency modulation modulator, the First and the second couplers being adapted to provide the respective outputs of the first and the second frequency modulation modulators to the transmission medium.

19. An apparatus for receiving a frequency modulated orthogonal frequency division multiplex (FM/OFDM) communication signal from a transmission medium, said FM/OFDM communication signal comprising an in-phase component and a quadrature component in separate frequency bands, said apparatus comprising:
first and second frequency modulation demodulators, the first frequency modulation demodulator adapted to receive the in-phase component from the transmission media and the second frequency modulation demodulator adapted to receive the quadrature component from the transmission media and each providing an OFDM output signal, said first and second demodulators being operative in separate frequency bands and
an assembly of digital signal processing units connected to respective outputs of said first frequency modulation demodulator and said second frequency modulation demodulator, said assembly of digital signal processing units being adapted to process the in-phase and the quadrature signals received respectively from the first frequency modulation demodulator and the second frequency modulation demodulator and to provide a baseband signal,
and wherein frequency modulation includes a modulation in which the instantaneous frequency of a carrier signal departs from the center frequency of said carrier signal by an amount proportional to the instantaneous value of a modulating signal.

20. The apparatus of claim 19, wherein the transmission medium is an electrical power line and the apparatus further includes:
a first coupler adapted to receive the in-phase component from the power line, and
a second coupler adapted to receive the quadrature phase component from the power line,
the first and the second couplers being adapted to provide respective outputs to the first and the second frequency modulation demodulators.

21. The apparatus of claim 19, wherein the transmission medium is an electrical power line, and the apparatus further includes a first coupler adapted to receive the FM/OFDM output signal from the first modulation modulator and a second coupler adapted to receiving the FM/OFDM output signal from the second modulation modulator and providing the FM/OFDM output signals to the transmission media.

22. The apparatus of claim 19, wherein each coupler is a capacitive transformer.

23. The apparatus of claim 19, wherein each coupler is a resin filled transformer.

24. The apparatus of claim 19, wherein each coupler is a dielectric filled transformer.

25. The apparatus of claim 19, wherein each coupler matches the power line characteristic impedance to the coupler and each coupler matches the characteristic impedance of the transmitter to the coupler.

26. The apparatus of claim 19, wherein the transmission media is selected from the group consisting of coaxial cable, twisted pairs, wireless and vehicle wiring harness.

27. An apparatus for transmitting a frequency modulated orthogonal frequency division multiplex (FM/OFDM) communication signal over a transmission medium comprising:
an assembly of digital signal processing units adapted to process an incoming baseband signal and to output an in-phase signal and a quadrature signal, the in-phase signal and the quadrature signal, in combination, forming an orthogonal frequency division multiplex (OFDM) signal;
a first frequency modulation modulator adapted to receive the sum of the in-phase and quadrature signal;
wherein the first frequency modulation modulator is adapted to provide an output to the transmission media in a frequency band,
and wherein frequency modulation includes a modulation in which the instantaneous frequency of a carrier signal departs from the center frequency of said carrier signal by an amount proportional to the instantaneous value of a modulating signal.

28. An apparatus for receiving a frequency modulated orthogonal frequency division multiplexed (FM/OFDM) communication signal from a transmission medium, said FM/OFDM communication signal comprising an in-phase component and a quadrature component in the same frequency band, said apparatus comprising:
first frequency modulation demodulator adapted to receive the in-phase and the quadrature component from the transmission media and providing an OFDM output signal, said first demodulator being operative in a frequency band; and
an assembly of digital signal processing units connected to respective outputs of said first frequency modulation demodulator, said assembly of digital signal processing units being adapted to process the in-phase and the quadrature signals received from the first frequency modulation demodulator and to provide a baseband signal,
and wherein frequency modulation includes a modulation in which the instantaneous frequency of a carrier signal departs from the center frequency of said carrier signal by an amount proportional to the instantaneous value of a modulating signal.

29. An apparatus for transmitting a coded and/or adaptive and/or orthogonal frequency modulated orthogonal frequency division multiplex (FM/OFDM) communication signal over a transmission medium comprising:
an assembly of digital signal processing units adapted to process an incoming baseband signal and to output an in-phase signal and a quadrature signal, the in-phase signal and the quadrature signal, in combination, forming an orthogonal frequency division multiplex (OFDM) signal;
a first frequency modulation modulator adapted to receive the sum of the in-phase and quadrature signal;
wherein the first coded and/or adaptive and/or orthogonal frequency modulation modulator is adapted to provide an output to the transmission media in a frequency band,
and wherein frequency modulation includes a modulation in which the instantaneous frequency of a carrier signal departs from the center frequency of said carrier signal by an amount proportional to the instantaneous value of a modulating signal.

30. An apparatus for receiving a coded and/or adaptive and/or orthogonal frequency modulated orthogonal frequency division multiplexed (FM/OFDM) communication signal from a transmission medium, said FM/OFDM communication signal comprising an in-phase component and a quadrature component in the same frequency band, said apparatus comprising:
first frequency modulation demodulator adapted to receive the in-phase and the quadrature component from the transmission media and providing an OFDM output signal, said first demodulator being operative in a frequency band; and
an assembly of digital signal processing units connected to respective outputs of said first coded and/or adaptive and/or orthogonal frequency modulation demodulator, said assembly of digital signal processing units being adapted to process the in-phase and the quadrature signals received from the first frequency modulation demodulator and to provide a baseband signal,
and wherein frequency modulation includes a modulation in which the instantaneous frequency of a carrier signal departs from the center frequency of said carrier signal by an amount proportional to the instantaneous value of a modulating signal.
